(19) United States
(12) Patent Application Publication
(10) Pub. No.: US 2003/0164890 A1
(43) Pub. Date: Sep. 4, 2003

(54) Image-capturing apparatus

(75) Inventors: Satoshi Ejima, Sakuragaoka (JP); Toshiaki Kobayashi, Nishi-shirakawa-gun (JP); Tomoaki Kawamura, Aoba-ku (JP); Kazuya Umeyama, Edogawa-ku (JP); Yoji Uchiyama, Asahi-ku (JP)

Correspondence Address: OLIFF & BERRIDGE, PLC, P.O. Box 19928, Alexandria, VA, 22320, US

(73) Assignee: Nikon Corporation

(21) Appl. No.: 10/384,729

(22) Filed: Mar. 11, 2003

Related U.S. Application Data
(63) Continuation of application No. 09/842,821, filed on Apr. 27, 2001, now abandoned.

(30) Foreign Application Priority Data
May 2, 2000 (JP) 2000-133734

(51) Int. Cl. H04N 5/222

(52) U.S. Cl. 348/333.1

(57) ABSTRACT

An image-capturing apparatus includes: an image-capturing element that captures an image of a subject through a photographic lens and outputs the captured image of the subject as image data; a display device that displays the image of the subject; a recording device that records the image data at a recording medium; a display control device that displays a first image prepared based upon the image data output by the image-capturing element and a second image prepared based upon the image data recorded at the recording medium on the display device; and an instruction device that issues an instruction to the display control device to display the first image and the second image in response to a user instruction operation when the first image is on display at the display device.

### INCORPORATION BY REFERENCE

The disclosure of the following priority application is herein incorporated by reference:

Japanese Patent Application No. 2000-133734 filed May 2, 2000

### BACKGROUND OF THE INVENTION

1. Field of the Invention

The present invention relates to an image-capturing apparatus that electronically captures an image of a subject and records the captured image as image data.

2. Description of the Related Art

Electronic cameras in the known art include those comprising a focal-point detection/adjustment device that performs focal-point detection by driving a photographic lens, an image-capturing element such as a CCD that captures a subject image having passed through the photographic lens and outputs image data, an image processing circuit that implements image processing such as white balance adjustment and γ correction on the image data output by the image-capturing element, a monitor that displays the data having undergone the image processing and a compression circuit that compresses the data having undergone the image processing through a method such as JPEG and records the compressed data in a recording medium such as a flash memory.

As a subject image is photographed through a shutter release operation and the image processing such as white balance adjustment and γ correction is performed on the image data output from the image-capturing element during a photographing operation performed by using such an electronic camera in the prior art, a photographic image referred to as a freeze image is displayed on the monitor over a specific length of time. Then, the compression processing for compressing the data having undergone the image processing and recording processing for recording the compressed data at the recording medium are implemented before the photographing operation ends.

When the specific length of time elapses after the freeze image is brought up on display, the subject image displayed on the monitor is automatically switched to a pre-photographing real time image referred to as a through image. For instance, a through image may be brought up on display when the photographic data have been compressed and stored in a memory card. Thus arises a problem in that after the monitor display at the camera is switched from the freeze screen to the through screen in the photographing mode, the recorded image can no longer be displayed on the monitor.

### SUMMARY OF THE INVENTION

An object of the present invention is to provide an image-capturing apparatus that allows a recorded image to be displayed simultaneously while a pre-photographing through image is on display.

In order to attain the above object, an image-capturing apparatus according to the present invention comprises: an image-capturing element that captures an image of a subject through a photographic lens and outputs the captured image of the subject as image data; a display device that displays the image of the subject; a recording device that records the image data at a recording medium; a display control device that displays a first image prepared based upon the image data output by the image-capturing element and a second image prepared based upon the image data recorded at the recording medium on the display device; and an instruction device that issues an instruction to the display control device to display the first image and the second image in response to a user instruction operation when the first image is on display at the display device.

In this image-capturing apparatus, it is preferred that a switching signal output device that outputs a signal for switching a frame of the second image which is currently on display at the display device is further provided, and the display control device switches the frame of the second image based upon a signal output from the switching signal output device.

Also, it is preferred that the display control device implements control on the display device so as to display at least two frames of the second image.

Also, it is preferred that the display control device reduces the second image and implements control on the display device so as to display the reduced second image by superimposing the reduced second image over a portion of the first image. In this case, it is preferred that the instruction device issues an instruction to the display control device so as to display an image by enlarging the reduced second image in response to a user instruction operation when the second image having been reduced is on display; and the display control device implements control on the display device so as to display the second image instead of the first image when the instruction device has issued an instruction to display an image by enlarging the reduced second image.

An image-capturing apparatus according to the present invention comprises: an image-capturing element that captures an image of a subject through a photographic lens and outputs the captured image of the subject as image data; a display device that displays the image of the subject; a recording device that records the image data in a recording medium and records reduced image data created by reducing the image data at the recording medium; a display control device that displays a first image prepared based upon the image data output by the image-capturing element and a second image prepared based upon the reduced image data having been recorded at the recording medium on the display device; and an instruction device that issues an instruction to the display control device to display the first image and the second image in response to a user instruction operation when the first image is on display at the display device.

In this image-capturing apparatus, it is preferred that the display control device implements control on the display device so as to display the second image by superimposing the second image over a portion of the first image.

Also, it is preferred that the instruction device issues an instruction to the display control device so as to display an image by enlarging the second image in response to a user instruction operation when the second image is currently on display; and when the instruction device has issued an instruction to display an image by enlarging the second image, the display control device implements control on the display device so as to display an image prepared based upon the image data recorded at the recording medium corresponding to the reduced image data with regard to which the instruction has been issued.

### BRIEF DESCRIPTION OF THE DRAWINGS

FIGS. 1A˜1C present external views of the electronic still camera in a first embodiment in storage and ready for use, with FIG. 1A presenting a top view, FIG. 1B presenting a rear view and FIG. 1C presenting a view of the electronic still camera with its lens driven out;

FIG. 2 is a circuit block diagram of the electronic still camera shown in FIG. 1A;

FIG. 3 shows a through image displayed on the LCD color monitor and marks indicating the focal adjustment areas;

FIG. 4A shows the initial display brought up in the settings screen;

FIG. 4B illustrates a state in which the item “White Balance Adjustment” has been selected;

FIG. 5A illustrates a state in which the white balance item selection submenu is on display;

FIG. 5B illustrates a state in which menu page 2 has been selected;

FIG. 6 shows part of an allocation map within the buffer memory;

FIG. 7 summarizes the differences in camera operation between the quick review mode and the reproduction mode;

FIG. 8 presents the first half of a flowchart of the photographing processing;

FIG. 9 is a flowchart of the preliminary image processing;

FIG. 10 is a flowchart of the synthesis processing;

FIG. 11 presents the second half of the flowchart of the photographing processing;

FIG. 12 is a flowchart of the menu processing; and

FIG. 13 illustrates part of a map provided in the buffer memory in a second embodiment.

### DESCRIPTION OF THE PREFERRED EMBODIMENTS

The following is an explanation of the embodiments of the present invention, given in reference to the drawings.

First Embodiment

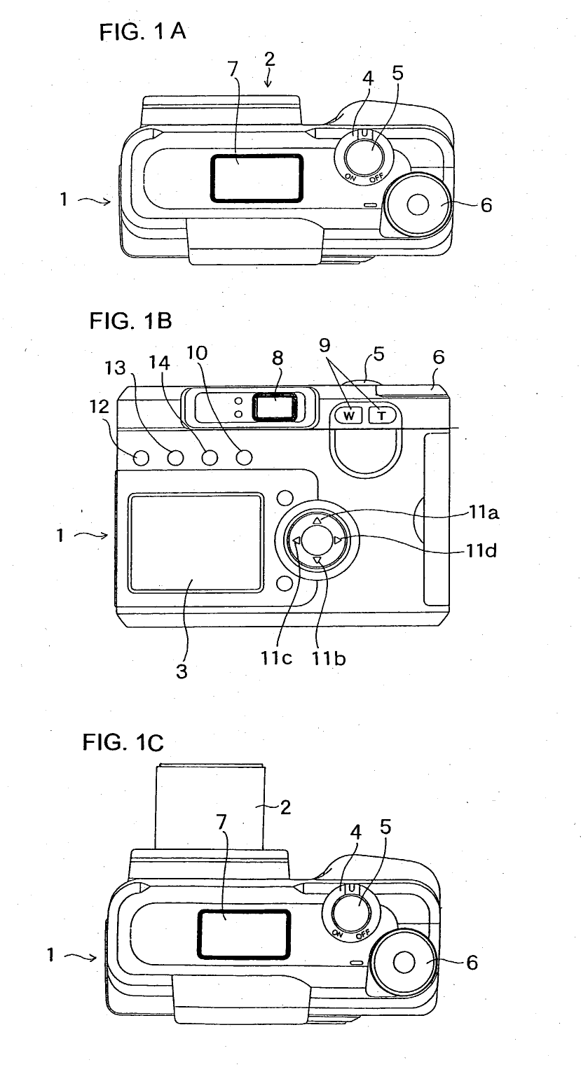

FIGS. 1A˜1C are the external views of the electronic still camera in the first embodiment of the present invention, with FIG. 1A presenting a top view, FIG. 1B presenting a rear view and FIG. 1C presenting a top view of the electronic still camera with its lens driven out. In FIG. 1A, an electronic still camera 1 is provided with a photographic zoom lens 2, a main switch 4, a shutter release button 5, a selector dial 6 and a display panel 7. In FIG. 1B, the electronic still camera 1 includes an LCD color monitor 3, a finder eyepiece window 8, a zoom selector button 9, a quick review button 10 and AF area selector buttons 11a˜11d. The shutter release button 5 is set higher than the selector dial 6 to facilitate operation. The quick review button 10 and the AF area selector buttons 11a˜11d are provided at positions which allow them to be operated with the right thumb while placing the right index finger on the shutter release button 5. The LCD color monitor 3 is not blocked by the right thumb during the operation.

In addition, the electronic still camera 1 is provided with a menu button 12, an electronic flash unit mode button 13, an exposure correction button 14 and the like.

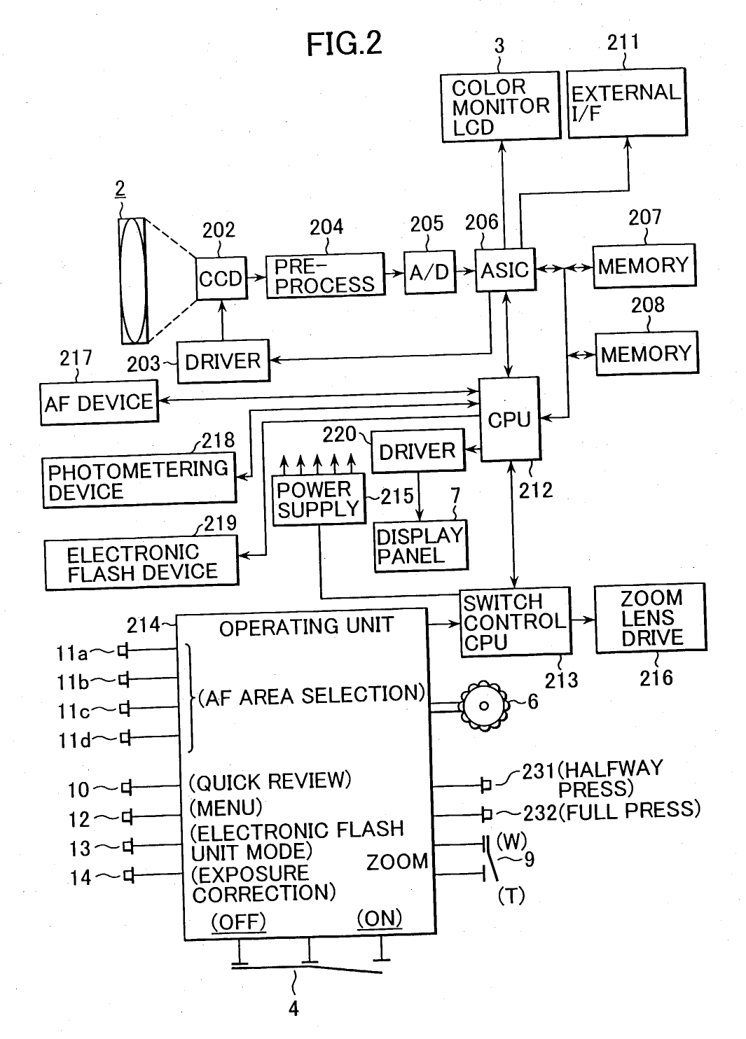

FIG. 2 is a circuit block diagram of the electronic still camera 1. The electronic still camera 1 is controlled by a main CPU 212 that controls focal-point detection/adjustment processing and photometric processing, an image processing ASIC 206 that controls image processing and image display processing and a switch control CPU 213 that controls signals input through various switches. When a switch at the electronic still camera 1 has been a operated, the switch control CPU 213 transmits information indicating that the switch has been operated to the CPU 212, whereas when the zoom selector button 9 has been operated, the switch control CPU 213 controls a zoom lens drive device 216 to drive the photographic zoom lens 2.

Power ON/OFF is switched through the main switch 4 in the electronic still camera 1. A photographing mode (REC) and a reproduction mode (PLAY) is selected by using the selector dial 6. The photographing mode is an operating mode in which a captured subject image is recorded as image data and the reproduction mode is an operating mode in which recorded image data are read out and displayed on the LCD color monitor 3. In addition, a menu setting mode may be selected in the electronic still camera 1 to select/set a camera operation. Since the embodiment is characterized by the operation performed in the photographing mode, the following explanation focuses on the photographing mode.

Photographing Mode

If the selector dial 6 is switched to the photographing mode position while the main switch 4 is in an ON state or if the main switch 4 is turned on while the selector dial 6 is set in the photographing mode, the electronic still camera 1 enters the photographing mode. When the electronic still camera 1 is in the photographing mode, the electronic still camera 1 shifts from the state shown in FIG. 1A to the state shown in FIG. 1C in which the photographic zoom lens 2 has been driven out. It is to be noted that while the photographic zoom lens 2, which has been driven out retracts to the state shown in FIG. 1A if the electronic still camera 1 is switched to the reproduction mode to be detailed later or the main switch 4 is turned off, it does not become retracted in a quick review mode, which is to be explained later. In the photographing mode, subject light entering the photographic zoom lens 2 is formed into an image on a CCD 202 constituting an image-capturing element. An image signal output from the CCD 202 is transmitted to an A/D conversion circuit 205 via a pre-process circuit 204 which engages in analog processing, and is converted to a digital signal at the A/D conversion circuit. The digitized image signal is guided to the image processing ASIC 206 where it undergoes preliminary image processing such as outline correction and γ correction, and is then temporarily stored in a memory 207 which is a buffer memory.

The image data stored in the buffer memory 207 are processed at the image processing ASIC 206 and become display image data. The image processing ASIC 206 reads out the image data having undergone preliminary image processing which are stored in the buffer memory 207 and creates a display image by performing, for instance, culling processing (image size compression processing) in correspondence to the display resolution of the LCD color monitor 3. The display image data created by the image processing ASIC 206 are displayed on the LCD color monitor 3 as a photograph monitor screen referred to as a through image. By performing the operation described above repeatedly, the through image is updated over specific intervals based upon the subject light entering the photographic zoom lens 2.

A halfway press signal and a full press signal are respectively input to the switch control CPU 213 through a halfway press switch 231 and a full press switch 232 (hereafter referred to as a shutter release switch 232) that interlock with the shutter release button 5. When the halfway press signal is input through an operation of the halfway press switch 231, the switch control CPU 213 communicates information indicating the input of a halfway press signal to the main CPU 212 and an AF device 217 detects the focal adjustment state of the photographic zoom lens 2 in response to a command issued by the CPU 212. The AF device 217, which is constituted of a light-receiving element that receives subject light for focal-point detection and a focal adjustment device (neither shown), drives the photographic zoom lens 2 to the focus position so as to form an image of the subject light entering the photographic zoom lens 2 on the CCD 202 constituting the image-capturing element based upon the focal-point detection data detected at the light-receiving element for focal-point detection. In addition, the CCD 202 is driven and controlled via a driver circuit 203 to achieve operating timing control on the pre-process circuit 204 and the A/D conversion circuit 205.

In addition, when the halfway press signal is input to the CPU 212, the CPU 212 also transmits a command to a photometering device 218 to implement brightness measurement on the subject. The photometering device 218, which is constituted of a light-receiving element (not shown), measures the brightness of the subject over, for instance, the area in which the focal adjustment state is detected by the AF device 217 mentioned earlier.

It is to be noted that the electronic still camera 1 allows either of two AF operating modes, i.e., a “single AF mode” and a “continuous AF mode” to be selected. In the “single AF mode”, a focal-point detection operation is performed by the AF device 217 in response to an operation of the halfway press switch 231 as explained earlier, whereas in the “continuous AF mode”, a focal-point detection/focusing operation is performed constantly by the AF device 217 if the electronic still camera 1 has been switched to the photographing mode.

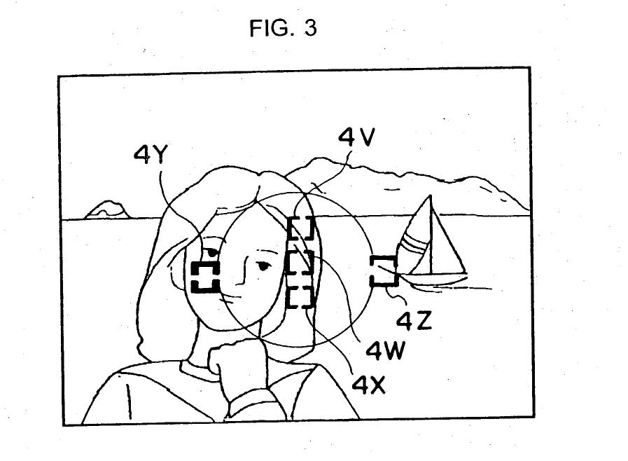

The AF area selector buttons 11a˜11d are now explained. The electronic still camera 1 is provided with five areas in the photographic field as areas over which the AF device 217 in FIG. 2 detects the focal adjustment state. An area in which the focal adjustment state is to be detected by the AF device 217 is selected from these five focal-point detection areas and is set as described below. In the photographing mode, marks indicating focal adjustment areas are superimposed on the through image on the LCD color monitor 3 of the electronic still camera 1. The through image and the marks indicating the focal adjustment areas displayed on the LCD color monitor 3 are shown in FIG. 3. In FIG. 3, five marks 4V˜4Z indicate the focal-point detection areas. A focal-point detection area is set by operating the AF area selector buttons 11a˜11d.

When the AF area selector button 11a is operated, the focal-point detection area 4W which is currently set in FIG. 3 is switched to the focal-point detection area 4V located above the focal-point detection area 4W. If the AF area selector button lib is then operated, the focal-point detection area 4W is selected again. By operating the AF area selector button 11c, the focal-point detection area 4Y located to the left of the focal-point detection area 4W is selected. Likewise, by operating the AF area selector button 11d while the focal-point detection area 4W is set, the focal-point detection area 4Z located to the right of the focal-point detection area 4W is selected.

The selected focal-point detection area is emphasized in the display as is the area 4Y in FIG. 3, for instance, compared to the marks corresponding to the other areas. The mark indicating the focal adjustment area is superimposed on the display by writing the image data having been stored at the buffer memory 207 following the preliminary image processing and the mark indicating the focusing area in the display area of the buffer memory 207.

Based upon the selection of one of the marks 4V˜4Z located on the main subject by the photographer, the AF device 217 detects the focusing position adjustment state in the focal-point detection area corresponding to the selected mark within the photographic image plane and drives the photographic zoom lens 2 to the focus position in conformance to the focal-point detection data. The AF area selector buttons 11a˜11d are used as described above in the normal photographing mode.

If the zoom selector button 9 is operated, the zoom lens drive device 216 drives the photographic zoom lens 2 in response to a command issued by the switch control CPU 213 to change the focal length. The focal length is changed to the side, i.e., either the telephoto side (T) or the wide angle side (W) that is pressed down at the zoom selector button 9.

When the shutter release switch 232 is turned on following the ON operation of the halfway press switch 231, an electronic flash unit 219 emits light based upon the results of the photometering operation having been performed by the photometering device 218 and the mode setting selected in advance. With an image of the subject light from the photographic zoom lens 2 formed on the light-receiving surface of the CCD 202, a signal charge corresponding to the brightness of the subject image is stored at the CCD 202. The signal charge stored at the CCD 202 is discharged by the driver circuit 203 and is input to the pre-process circuit 204 that includes an AGC circuit and a CDS circuit and engages in analog signal processing. The analog image signal having undergone the analog processing such as gain control and noise removal at the pre-process circuit 204 is then converted to a digital signal at the A/D conversion circuit 205.

The digitized signal is then guided to the image processing ASIC 206 where it undergoes the preliminary image processing including outline correction and γ correction and then it is temporarily stored at the buffer memory 207. The CPU 212 and the buffer memory 207 engage in image data exchange, a white balance adjustment value is ascertained by using the stored image data, a white balance adjustment is performed by the image processing ASIC 206 based upon the adjustment value and the image data having undergone the white balance adjustment are stored back into the buffer memory 207.

The image data having undergone the preliminary image processing described above further undergo format processing (post image processing) for JPEG compression, implemented by the image processing ASIC 206, and the image data having undergone the post image processing are compressed at a specific rate through the JPEG method. The image data that have been compressed through the JPEG method are assigned with a specific data name by the CPU 212 and then are recorded at a memory 208 constituting a recording medium (a PC card, a CF card or the like) such as a flash memory. When the recording processing for recording the data into the memory 208 is completed, the photographing processing ends.

In addition, a display panel driver circuit 220 is connected to the CPU 212 to allow the flash mode setting at the electronic flash unit 219 selected through the electronic flash unit mode button 13, the number of photographs that have been taken and the like to be displayed on the display panel 7. An external I/F circuit 211 is connected to the image processing ASIC 206 to allow the display image data to be output as a video signal.

Reproduction Mode

If the selector dial 6 is switched to the reproduction mode position while the main switch 4 is in an ON state or if the main switch 4 is turned on while the selector dial 6 is set in the reproduction mode, the electronic still camera 1 enters the reproduction mode. As the electronic still camera 1 is switched from the photographing mode to the reproduction mode, the electronic still camera 1 shifts from the state shown in FIG. 1C to the state shown in FIG. 1A in which the photographic zoom lens 2 is retracted. In the reproduction mode, if image data have already been recorded in the memory 208, the recorded image data are read into the CPU 212. The data having been read into the CPU 212 are sent to the buffer memory 207 and then undergo processing implemented by the image processing ASIC 206 to become display image data. Thus, a reproduced image is displayed on the LCD color monitor 3. While the reproduced image is displayed on the LCD color monitor 3 in the reproduction mode, the subject image captured through the photographic zoom lens 2 (through image screen) is not displayed. In addition, no exposure adjustment (AE) is performed based upon the results of a photometering operation performed by the photometering device 218 and no focal adjustment state detection (AF) by the AF device 217 is performed, either.

Menu Setting

The menu button 12 is used to set details of the photographing conditions and the like for the electronic still camera 1. If the menu button 12 is operated while the electronic still camera 1 is set in the photographing mode, a settings screen is brought up on display. It is to be noted that while settings made through the menu button 12 are also valid while the electronic still camera 1 is set in the reproduction mode, an explanation is given on a state in which the electronic still camera 1 is set in the photographing mode since the embodiment is characterized by its operation achieved in the photographing mode.

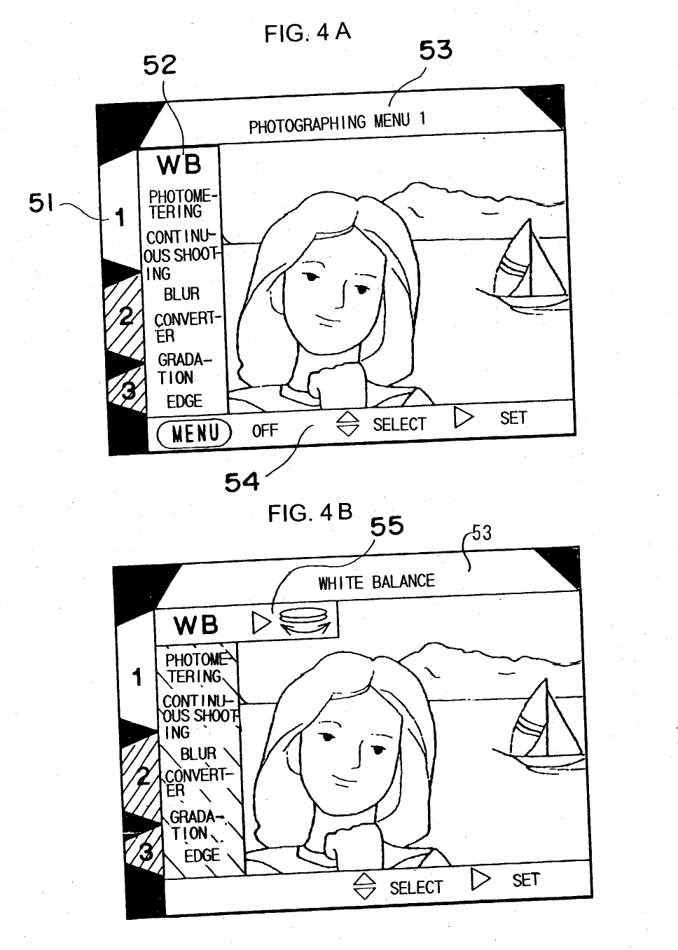

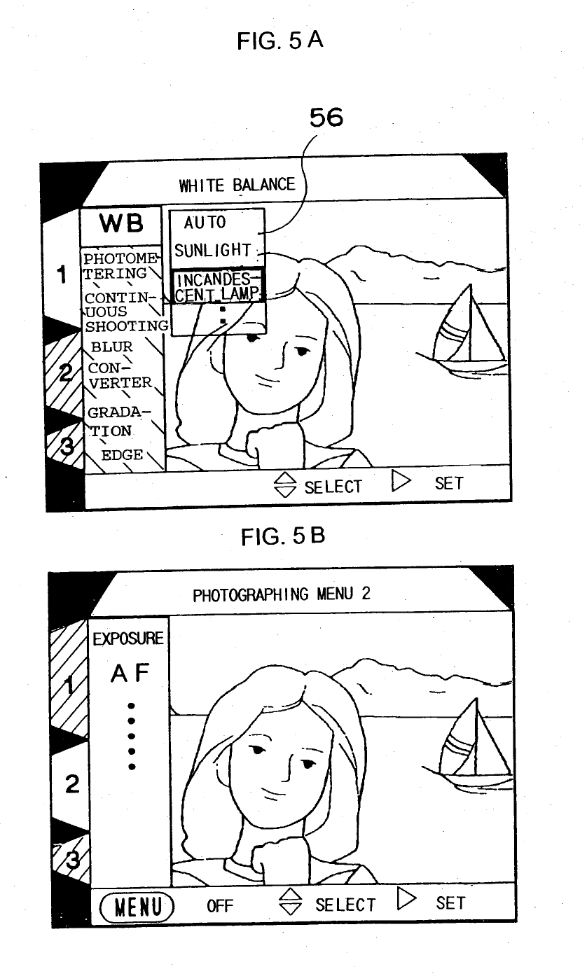

The settings screen is superimposed over the through image screen displayed on the LCD color monitor 3. The processing for bringing up the superimposed display is implemented by the image processing ASIC 206 in response to a command issued by the CPU 212. The marks 4V˜4Z (see FIG. 3) indicating the focal-point detection areas mentioned earlier are not displayed in an overlay while the superimposed display of the settings screen is up. FIGS. 4A and 4B and FIGS. 5A and 5B show the settings screens displayed in an overlay on the LCD color monitor 3 of the electronic still camera 1, and FIG. 4A shows the initial screen brought up in the superimposed display.

In FIG. 4A, the settings screen contains a menu page number display section 51, a first item display section 52, a tag display section 53 and a first operating instruction display section 54. For instance, if there are 21 items including the photographing conditions to be set for the electronic still camera 1, the setting items are divided into groups each constituted of a specific number of items and are displayed in a menu format in units of the individual groups. One page corresponds to a given group constituted of the specific number of setting items, with the settings screen out constituted of a plurality of pages. In the embodiment, the number of setting items that can be displayed in one screen on the LCD color monitor 3 is set at 7 by taking into consideration the display resolution of the LCD color monitor 3 and the ease of recognition of the setting items displayed on the LCD color monitor 3, and the total of 21 setting items are managed over three pages by providing the 1st˜7th setting items in the menu on page 1, providing the 8th˜14th setting items in the menu on page 2 and providing the 15th˜21st setting items in the menu on page 3. It is to be noted that new setting items may be added by creating a page 4 and subsequent pages.

The menu page numbers are displayed in the menu page number display section 51. The menu page number that has been selected with the cursor from these page numbers, is emphasized (not shaded in the figure) unlike the other page numbers that have not been selected. In FIG. 4A presenting the initial screen brought top when the settings screen display is selected, page 1 has been automatically selected. At this time, “photographing menu 1” corresponding to the contents of page 1 is displayed in the tag display section 53. In the first item display section 52, the first˜seventh setting items contained in page 1 are displayed. In the embodiment, “WB” represents the setting item related to the white balance adjustment, “photometering” represents the setting item related to the photometering method, “continuous shooting” represents the setting item related to continuous shooting, “blur” represents the setting item related to hand-movement blur reduction processing, “converter” represents the setting item related to the converter lens, “gradation” represents the setting item related to gradation correction and “edge” represents the settings item related to edge emphasis. The items displayed in the first item display section 52 include setting items related to the shutter speed and the aperture value constituting the photographing conditions. The setting items may be displayed as icons that correspond to the individual setting items instead of using characters. In addition, they may be displayed to allow the photographer to ascertain the setting states.

In the first operating instruction display section 54, the operating switches that are required in the settings screen on display and the instructions for their operation are displayed. In the example shown in FIG. 4A, the settings screen display is turned off by operating the menu button 12 and a page is selected by operating the AF area selector button 11a pointing upward or the AF area selector button 11b pointing downward.

The cursor is moved to select a page number by using the AF area selector buttons 11a˜11d explained earlier. While the setting change screen is displayed on the LCD color monitor 3, the AF area selector buttons 11a˜11d are used to move the cursor position up/down and to the left/right. For instance, if the AF area selector button 11b pointing downward is pressed while page 1 has been selected and “1” in the menu page number display section 51 is emphasized in the display, the cursor moves down to select page 2. Once page 2 is selected, “2” becomes emphasized in the menu page number display section 51 and the 8th˜14th setting items on page 2 are displayed. Likewise, if page 3 is selected, “3” becomes emphasized in the menu page number display section 51 and the 15th˜21st setting items on page 3 are displayed.

Next, the operation for setting the setting items contained in the individual pages is explained. For instance, if the AF area selector button 11d pointing to the right is operated while page 1 has been selected, as shown in FIG. 4A, the first selection item in the first item display section 52 is selected with the cursor. If the AF area selector button 11d pointing to the right is operated again in this state, the white balance adjustment, which is the first setting item, is selected, as shown in FIG. 4B. At this time, “WB” becomes emphasized in the first item display section 52, “white balance” is displayed in the tag display section 53 and a second operating instruction display section 55 is brought up on display in addition. In the second operating instruction display section 55, switches that should be operated to set a specific setting item are displayed. In the example shown in FIG. 4B, the AF area selector button 11d pointing to the right or the selector dial 6 (see FIG. 1A) should be operated.

If the AF area selector button 11d pointing to the right is operated while the setting item “white balance adjustment” is selected, a second item display section 56 shown in FIG. 5A is brought up on display, as shown in FIG. 5A. In the second item display section 56, selection items corresponding to the setting item which has been selected in the first item display section 52 are displayed. In the example in FIG. 5A, selection items related to the white balance adjustment are displayed, with the selection item having been selected with the cursor emphasized (not shaded in the figure) unlike the other selection items that have not been selected. For instance, if “incandescent lamp” among “auto”, “sunlight”, “incandescent lamp” . . . is selected by the photographer using the AF area selector button 11a pointing upward or the AF area selector button 11b pointing downward in FIG. 5A, the image processing ASIC 206 described earlier engages in a white balance adjustment for illuminating light emitted by an incandescent lamp. Namely, once a selection item is selected with the cursor, the setting state within the electronic still camera 1 immediately changes.

If the AF area selector button 11d pointing to the right is operated while the second item display section 56 shown in FIG. 5A is on display, the settings screen for selecting a page number in FIG. 4 is brought back on display. By operating the AF area selector button 11a pointing upward and the AF area selector button 11b pointing downward in this state, another page number can be selected. In addition, the superimposed display of the settings screen is turned off by operating the menu button 12.

Either of the two AF operating modes, i.e., the “single AF mode” and the “continuous AF mode” mentioned earlier is also selected and set by using a settings screen brought up by operating the menu button 12. The AF area selector buttons 11a˜11d are operated to select, for instance, the item corresponding to the AF operation from the setting items contained in page 2. FIG. 5B shows the state in which page 2 has been selected. When “AF” is selected by operating the AF area selector button 11d, selection items (not shown) related to the AF operation are displayed in the second item display section 56. The selection items include the “continuous AF mode” and the “single AF mode”, and either selection item can be selected by operating the AF area selector button 11a pointing upward and the AF area selector button 11b pointing downward with the selection finalized by operating the AF area selector button 11d pointing to the right.

The settings selected in the settings screen brought up by operating the menu button 12 become effective immediately without having to turn off the superimposed change screen display by pressing the menu button 12 again. Thus, by implementing the gradation correction for adjusting the image brightness and the exposure correction for adjusting the aperture value for exposure on the settings screen in addition to the white balance adjustment included among the setting items in page one, the through image displayed on the LCD color monitor 3 changes in conformance to the details set on the settings screen. As a result, the photographer is able to change settings while ensuring in real time that the white balance adjustment, the gradation correction or the exposure correction is performed correctly by viewing the through image displayed together with the settings screen on the LCD color monitor 3.

The electronic still camera 1 performs a photographing operation in conformance to the setting details having been selected with the cursor at a point in time at which an ON operation is performed at the shutter release button 5 while the superimposed display of the settings screen brought up on display by operating the menu button 12 is on. In other words, if the shutter release switch 23 is operated after selecting one of the selection items displayed in the second item display section 56 with the cursor, the details having been selected with the cursor are reflected in the photographing processing even though they have not been finalized by operating the AF area selector button 11d pointing to the right.

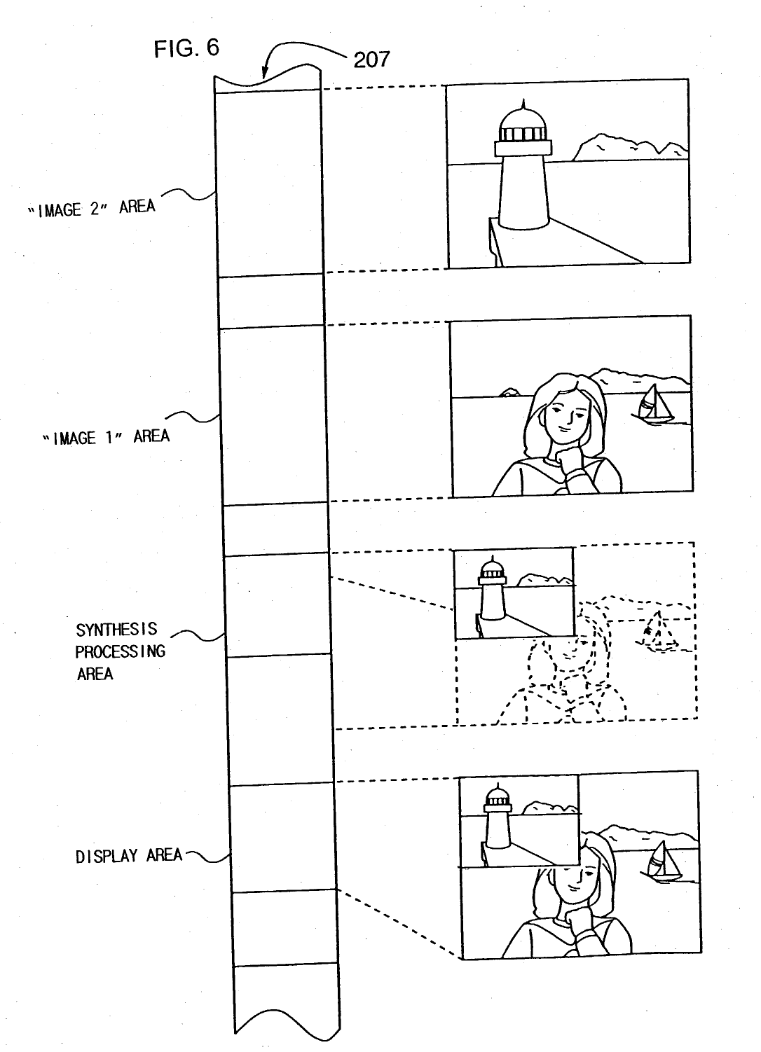

Next, the quick review button 10 is explained. FIG. 6 shows part of a map allocated within the buffer memory 207. In FIG. 6, the buffer memory 207 is divided into, at least, dedicated storage areas for “image 2” data and “image 1” data, a synthesis processing area in which the “image 1” and “image 2” data are reduced and synthesized and a display area in which display image data resulting from the culling processing implemented in correspondence to the display resolution of the LCD color monitor 3 are stored. Examples of images stored in the individual areas are shown on the right side of the figure. The image displayed on the LCD color monitor 3 of the electronic still camera 1 corresponds to the image data stored in the display area shown at the bottom of FIG. 6. If the quick review button 10 is operated when the electronic still camera 1 is set in the photographing mode and the through image shown in FIG. 3 is displayed on the LCD color monitor 3, the image processing ASIC 206 reads out image data that have been most recently recorded from the memory 208 which may be a CF card. The image processing ASIC 206 decompresses the image data thus read out and stores them in the “image 2” area in the buffer memory 207 in FIG. 6.

The “image 2” data having been stored in the “image 2” area of the buffer memory 207 then undergo culling processing implemented by the image processing ASIC 206 so as to reduce the display area to ¼ of the full screen display based upon a specific reduction rate set in advance. The “image 2” data having undergone the culling processing are synthesized with the “image 1” data having been stored in the “image 1” area of the buffer memory 207 and the synthesized data are copied into the synthesis processing area of the buffer memory 207, as shown in FIG. 6. In other words, the image data are synthesized so as to overwrite part of the “image 1” data with the reduced “image 2” data.

The synthesized image resulting from the synthesis performed in the synthesis processing area of the buffer memory 207 undergoes culling processing implemented in correspondence to the display resolution of the LCD color monitor 3. When the synthesized image data resulting from the culling processing are written in the display area of the buffer memory 207, picture-in-picture display is brought up on the LCD color monitor 3. Namely, the reproduced image, i.e., the “image 2”, in a ¼ size is displayed over the through image, i.e., the “image 1”. Since the through image is displayed over ¾ of the display screen of the LCD color monitor 3, reproduction/display of the recorded image is enabled while the display screen is still utilized as an electronic view finder.

If the quick review button 10 is operated again in this state, the image processing ASIC 206 overwrites the display area of the buffer memory 207 with the “image 2” data having been stored in the “image 2” area of the buffer memory 207. As a result, full screen display of the “image 2” is brought up on the LCD color monitor 3. Subsequently, each time the quick review button 10 is operated, the image processing ASIC 206 alternately overwrites the display area of the buffer memory 207 with the image data having been stored in the synthesis processing area of the buffer memory 207 and the “image 2” data having been stored in the “image 2” area of the buffer memory 207. Thus, the picture-in-picture display and the full screen display of the generated image, i.e., the “image 2” are alternately brought up on the LCD color monitor 3. The display mode in which display is brought up by operating the quick review button 10 as described above is referred to as a quick review mode. The quick review mode can be cleared only when the halfway press switch 231 is operated. Once the quick review mode is cleared, the operation returns to the normal photographing mode.

The operation of the AF area selector buttons 11c and 11d in the quick review mode is explained. If the AF area selector button 11c or 11d is operated in the quick review mode, the image processing ASIC 206 switches the frame of the image data read out from the memory 208. Namely, if the AF area selector button 11c is operated, the image processing ASIC 206 reads out the image data having been obtained through the photographing operation corresponding to the preceding frame and recorded in the memory 208, decompresses the image data thus read out and overwrites the “image 2” area of the buffer memory 207 with the decompressed image data. The new “image 2” data are immediately used in the display on the LCD color monitor 3 brought up in the quick review mode explained earlier.

If, on the other hand, the AF area selector button 11d is operated in the quick review mode, the image processing ASIC 206 reads out the image data in the following frame having been recorded in the memory 208 decompresses the image data thus read out and overwrites the “image 2” area of the buffer memory 207 with the decompressed image data. The “image 2” data corresponding to the following frame that have been overwritten into the “image 2” area are immediately displayed on the LCD color monitor 3.

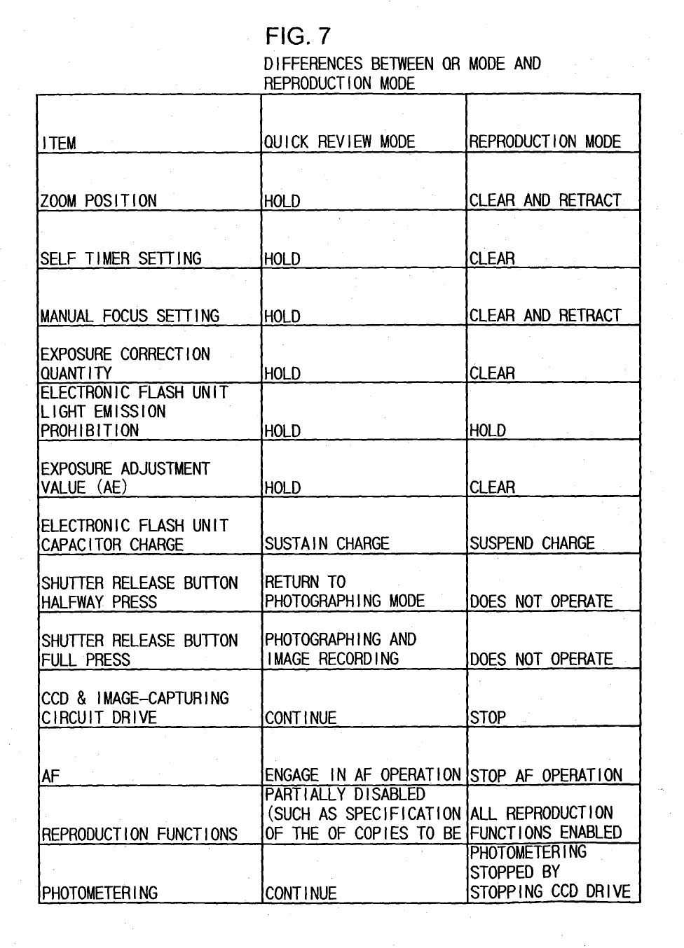

In addition to switching the display at the LCD color monitor 3, the camera operations are performed as shown in FIG. 7 in the quick review mode. FIG. 7 summarizes the differences in the camera operation between the quick review mode and the reproduction mode. The items listed in FIG. 7 correspond to the following contents. The term “zoom position” refers to the setting state for the focal length of the photographic zoom lens 2 set by operating the zoom selector button 9. The self timer setting represents the self timer operating state. The manual focus setting represents the focal position adjustment state of the photographic zoom lens 2 achieved through manual focal adjustment. The term “exposure correction quantity” represents the correction value set for implementing exposure correction. The term “electronic flash unit light emission prohibition” refers to the setting state in which light emission from the electronic flash unit is prohibited. The term “exposure adjustment value” represents the shutter speed and the aperture value determined based upon the photometering results.

The term “electronic flash unit capacitor charge” refers to the charging operation performed to supply power to the circuit (not shown) which causes the electronic flash unit to emit light. The term “shutter release button halfway press” represents the camera operation performed in response to an operation of the halfway press switch 231. The term “shutter release button full press” represents the camera operation performed in response to an operation of the shutter release switch 232. The term “CCD and image-capturing circuit drive” corresponds to the operation of the image-capturing circuit that includes the CCD 202, the driver 203, the pre-process circuit 204 and the A/D conversion circuit 205. The term “AF” represents the AF operation performed by the AF device 217. The term “reproduction function” represents the operation through which image data recorded at the memory 208 are read out and displayed on the LCD color monitor 3. The term “photometering” represents the photometering operation performed by the photometering device 218.

Since the quick review mode is a photographing mode in which the reproduction function is enabled, the details of the operations corresponding to individual items that are performed in the normal photographing mode are sustained regardless of whether or not the quick review mode is set, as indicated with the terms “hold” and “continue” in FIG. 7. Immediately after the halfway press switch 231 is operated, the quick review mode is exited and the photographing mode is restored, and in response to an operation of the shutter release switch 232, photographing/recording operations are performed. In other words, the CPU 212 stores the state immediately before the operation of the quick review button 10 in its internal memory and restores the state thus stored when the halfway press switch 231 is operated. In the reproduction mode, on the other hand, all the operations related to photographing are either cleared or suspended. In addition, any operations of the halfway press switch 231 and the shutter release switch 232 become invalid.

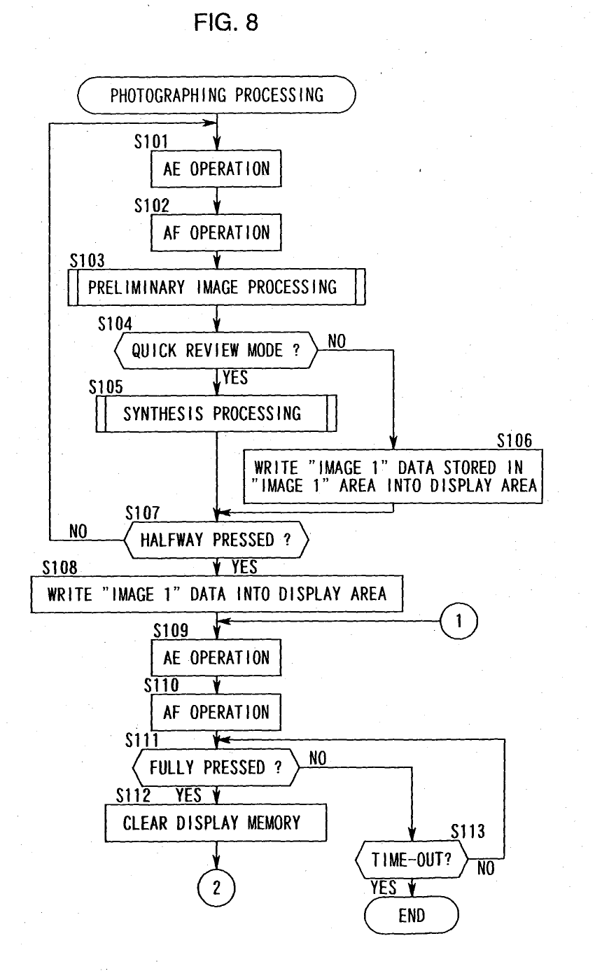

The photographing processing implemented in the electronic still camera 1 explained above is now described in reference to the flow charts in FIGS. 8˜12. When the electronic still camera 1 is switched to the photographing mode in FIG. 8, a photographing processing program is started up. In step S101, an exposure adjustment (AE) is performed based upon the photometering results obtained by the photometering device 218 (see FIG. 2), and in the following step S102, a focal-point detection and a focal adjustment (AF) are performed by the AF device 217. Once the AF operation is completed, preliminary image processing is implemented in step S103.

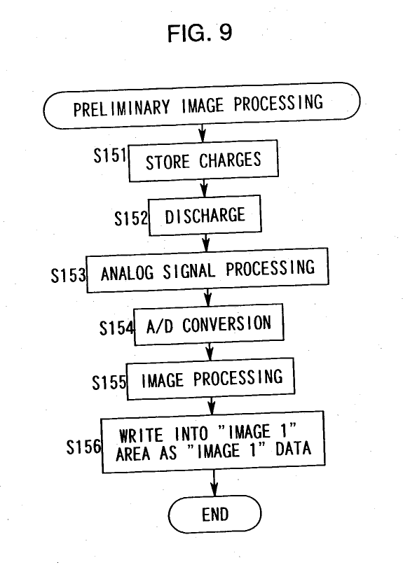

The preliminary image processing is now explained in reference to the flowchart in FIG. 9 showing the flow of the processing. In step S151, electrical charges corresponding to the brightness levels of the subject light are stored at the CCD 202 (see FIG. 2) and in step S152, the electrical charges having been stored at the CCD 202 are sequentially discharged and input to the pre-process circuit 204. In step S153, the pre-process circuit 204 implements analog signal processing on the charge signals having been input thereto. In step S154, image signals having undergone the analog signal processing are input to the A/D conversion circuit 205 to be converted from the analog signals to digital signals. In step S155, the digitized image data undergo subsequent image processing such as outline correction and gamma correction implemented by the image processing ASIC 206. The image data are then temporarily stored in the buffer memory 207, and further undergo image processing such as white balance adjustment. In step S156, the image data having undergone the image processing are written into the “image 1” area of the buffer memory 207 as “image 1” data, before the preliminary image processing in FIG. 9 ends.

When the preliminary image processing described above ends, a decision is made in step S104 in FIG. 8 as to whether or not the quick review mode has been set. An affirmative decision is made if the quick review mode has been set and the operation proceeds to perform synthesis processing in step S105. If, on the other hand, the quick review mode has not been set, negative decision is made and the operation proceeds to step S106. In step S106, the “image 1” data stored in the “image 1” area of the buffer memory 207 are read out and written into the display area of the buffer memory 207 before the operation proceeds to step S107.

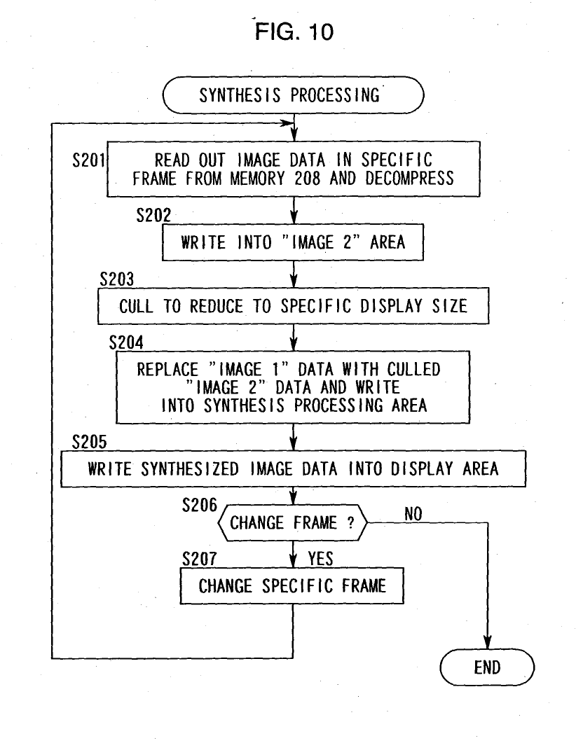

The synthesis processing implemented in step S105 is now explained in reference to the flowchart in FIG. 10 that illustrates the flow of the processing. In step S201, image data in a specific frame in the image data recorded at the memory 208 which may be a CF card are read out and decompressed. In step S202, the decompressed image data are written into the “image 2” area of the buffer memory 207 as “image 2” data. In step S203, the “image 2” data in the “image 2” area undergo culling processing so as to reduce the display area to ¼ of the full screen display on the LCD color monitor 3 based upon a predetermined reduction rate, and then the operation proceeds to step S204.

In step S204, the “image 1” data having been stored in the “image 1” area of the buffer memory 207 are copied into the synthesis processing area. During this process, the “image 1” data are synthesized with the “image 2” data having undergone the culling processing in step S203 and the resulting synthesized data are copied. In other words, the image data are synthesized (superimposed) so that part of the “image 1” data are overwritten (replaced) with the “image 2” data having been reduced through the culling processing. The synthesized image resulting from the synthesis implemented in the synthesis processing area of the buffer memory 207 further undergoes culling processing implemented in correspondence to the display resolution of the LCD color monitor 3 and then is written into the display area of the buffer memory 207. As a result, a picture-in-picture image is displayed on the LCD color monitor 3.

In step S206, a decision is made as to whether or not an operation to change the frame of the “image 2” data has been performed through the AF area selector button 11c or 11d. If an affirmative decision that a frame change operation has been performed is made, the operation proceeds to step S207. In step S207, the frame number of the image data to be read out from the memory 208 next is changed. Once the frame number of the image data to be read out next is changed, the operation returns to step S201 to repeat the processing described above. If, on the other hand, a negative decision that a frame change operation has not been performed is made in step S206, the synthesis processing in FIG. 10 ends.

When the synthesis processing described above ends, a decision is made in step S107 in FIG. 8 as to whether or not the halfway press switch 231 has been operated. If an affirmative decision that the halfway press switch 231 has been operated is made, the operation proceeds to step S108. In step S108, culling processing is implemented on the “image 1” data stored in the “image 1” area of the buffer memory 207 in conformance to the display resolution of the LCD color monitor 3 and the display area of the memory 208 is overwritten with the culled image data. As a result, a through image captured by the CCD 202 is displayed on the LCD color monitor 3, and if the quick review mode is currently set, the operation exits the quick-review mode. If, on the other hand, a negative decision that a halfway press operation has not been performed is made in step S107, the operation returns to step S101 to repeat the processing described above.

After a photographing AE operation is performed in step S109 and the AE operation ends, a photographing AF operation is performed in the following step S110. When the AF operation ends, the results of the AE operation and the AF operation are held at the CPU 212, and a decision is made in step S111 as to whether or not the shutter release switch 232 has been operated.

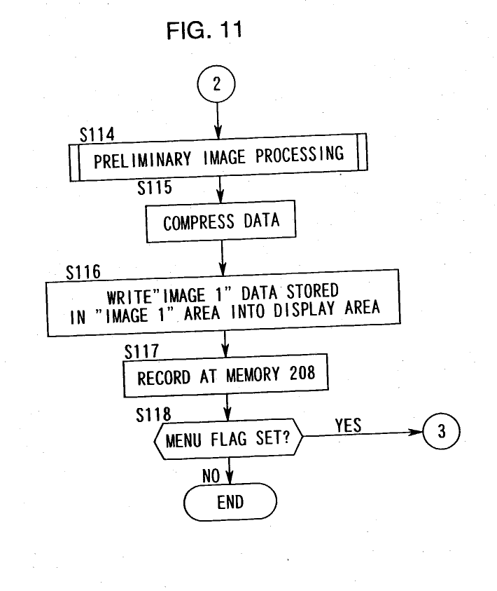

If an affirmative decision that the shutter release switch 232 has been operated is made in step S111, the data in the display area of the buffer memory 207 are first cleared to black out the display on the LCD color monitor 3 in step S112, before the operation proceeds to step S114 in FIG. 11. If, on the other hand, a negative decision that the shutter release switch 232 has not been operated is made in step S111, a decision is made in step S113 as to whether or not a time-out has occurred. If a negative decision that a time-out has not occurred is made, the results of the AE operation and the AF operation are held at the CPU 212 before the operation returns to step S111 to await an operation of the shutter release switch 232. If it is decided in step S113 that a time-out has occurred, the photographing processing in FIG. 8 ends.

FIG. 11 is a flowchart showing the flow of the second half of the photographing processing. In step S114, preliminary image processing similar to that performed in step S103 is implemented. When the preliminary image processing in step S114 ends, the “image 1” data stored in the “image 1” area of the buffer memory 207 are culled in conformance to the display resolution of the LCD color monitor 3 and the display area in the buffer memory 207 is overwritten with the culled image data in step S116. As a result, a freeze image captured by the CCD 202 is displayed on the LCD color monitor 3. In step S117, the image data having undergone the preliminary image processing undergo post image processing so that they are compressed at a predetermined rate through a JPEG method or the like, and the compressed image data are assigned with a specific image data name by the CPU 212 and recorded into the memory 208 such as a CF card.

In step S118, a decision is made as to whether or not a menu flag to be detailed later has been set. If a negative decision that the menu flag has not been set is made, the processing in FIG. 11 ends. If, on the other hand, an affirmative decision that the menu flag has been set is made in step S118, the operation jumps to menu processing which is to be explained next.

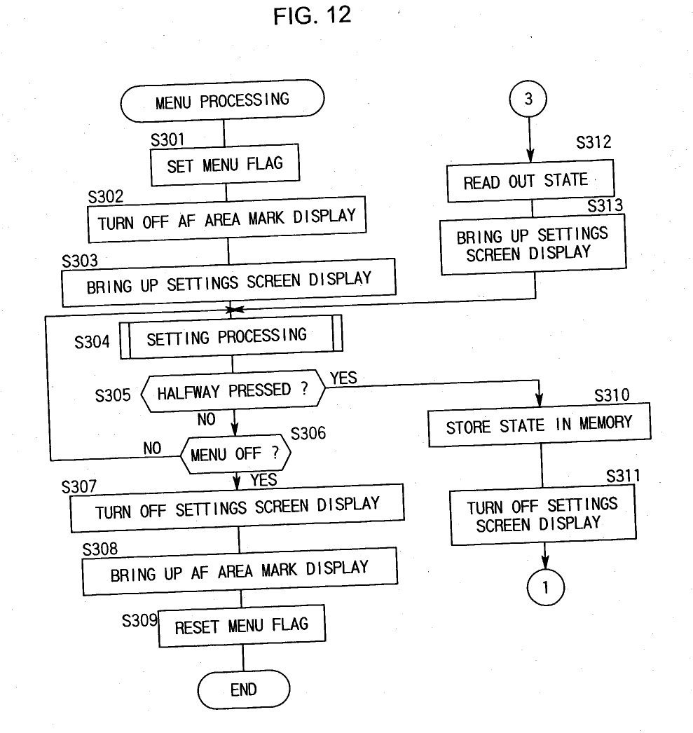

The menu processing achieved in the electronic still camera 1 is now explained in reference to the flowchart in FIG. 12. The menu processing in FIG. 12 is started up in response to an operation of the menu button 12. In step S301, the menu flag indicating that the execution of the menu processing is in progress is set at the CPU 212, and in step S302, the display of the AF area indicator marks 4V˜4Z (see FIG. 3) is turned off. In step S303, the settings screen display is superimposed on the through image on display. In step S304, the processing for setting the various setting items explained earlier is implemented. In step S305, a decision is made as to whether or not an ON operation has been performed at the halfway press switch 231, and the operation proceeds to step S306 if a negative decision is made, whereas the operation proceeds to step S310 if an affirmative decision is made.

In step S306, a decision is made as to whether or not a menu processing OFF operation has been performed through the menu button 12. If an affirmative decision that an OFF operation has been performed is made, the operation proceeds to step S307 to turn off the superimposed display of the settings screen. If, the other hand, a negative decision that an OFF operation has not been performed is made in step S306, the operation returns to step S304 to repeat the setting processing. In step S308, the display of the AF area indicator marks 4V˜4Z (see FIG. 3) is brought up and after resetting the menu flag in step S309, the processing in FIG. 12 ends.

In step S310, the state of the settings screen, i.e., information with regard to the menu page number of the menu page currently on display and the setting items currently selected with the cursor, is stored in the memory within the CPU 212. After the superimposed display of the settings screen is turned off in the following step S311, the operation jumps to step S109 of the photographing processing in FIG. 8.

If an affirmative decision is made in step S118 in FIG. 11, the processing in step S312 and subsequent steps in FIG. 12 is implemented. In step S312, the state of the settings screen having been stored in memory in step S310 as explained earlier is read out. After bringing up the superimposed display of the settings screen based upon the information related to the settings screen thus read out in step S313, the setting processing in step S304 is implemented.

As explained above, the first embodiment achieves the following advantages.

(1) Since a photographic image screen that has been recorded in the memory 208, i.e., “image 2” data, is superimposed over the through image captured by the CCD 202, i.e., “image 1” data on display at the LCD color monitor 3 by pressing the quick review button 10 in the photographing mode, it is possible to check the photographed “image 2” while verifying the subject image to be photographed next with the “image 1”. As a result, even when photographing the same subject, for instance, the composition of the next picture to be photographed can be determined by comparing/verifying the composition of the photographed “image 2”.

(2) In addition to the advantage in (1), the “image 2” data are brought up in full screen display at the LCD color monitor 3 by pressing the quick review button 10 again. Thus, the reproduced image can be checked without having to switch the electronic still camera 1 to the reproduction mode, achieving an improvement in the camera operability.

(3) The frame corresponding to the “image 2” data read out from the memory 208 and displayed on the LCD color monitor 3 can be switched by operating the AF area selector button 11c or 11d. This achieves a higher degree of ease in the operation of the camera since the image in another frame as well as the image in the frame photographed immediately before can be displayed through a simple operation.

(4) The quick review mode for displaying the “image 2” data is immediately exited if the halfway press switch 231 is operated to set the camera in the photographing mode. In addition, as shown in FIG. 7, the camera operations for photographing that are either cleared or suspended in the reproduction mode are held or continued even while the “image 2” is displayed in the quick review mode, thereby making it possible to perform a photographing operation immediately by operating the shutter release button 5 even in the quick review mode.

(5) When a full screen display of the “image 2” data is not up, the “image 2”, data having been reduced to ¼ of the “image 1” data are displayed, and thus, the “image 1” data display screen can still be viewed since it is not hidden under the “image 2” data.

Second Embodiment

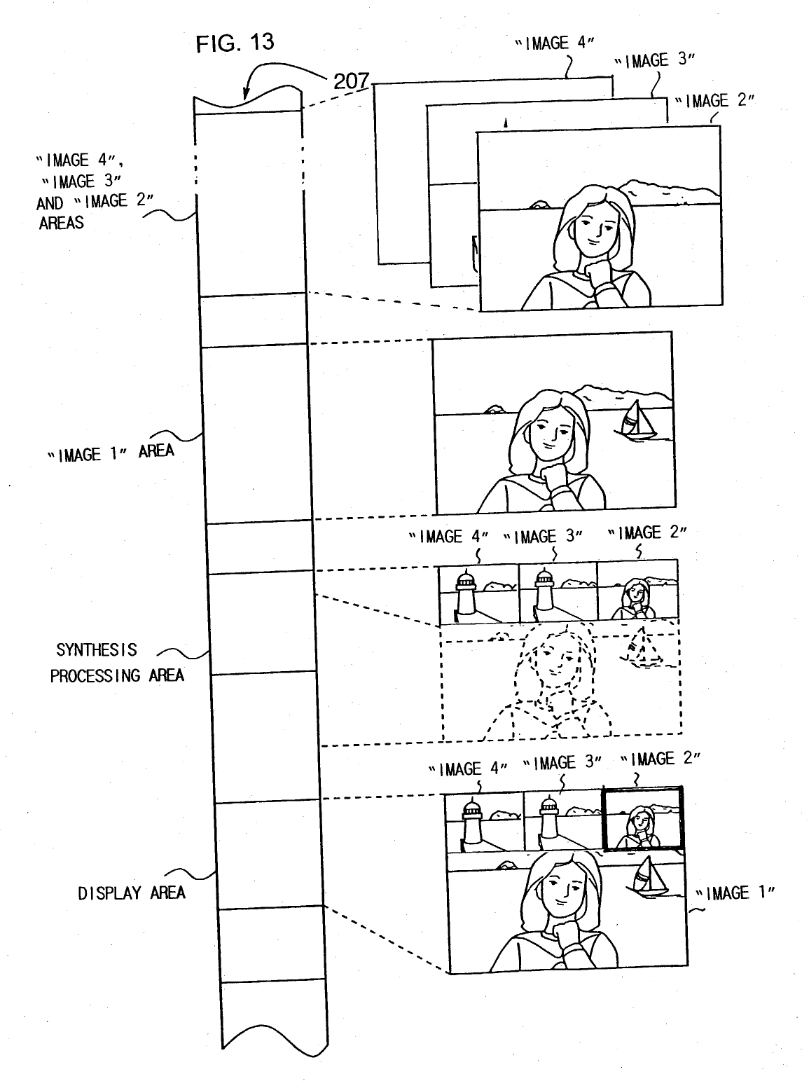

In the quick review mode, thumbnail images corresponding to the most recent three images among the photographic images having been recorded at the memory 208 may be superimposed on the through image captured by the CCD 202, i.e., the “image 1” data, in the display at the LCD color monitor 3. FIG. 13 shows part of the map allocated within the buffer memory 207 in the second embodiment. In FIG. 13, the buffer memory 207 is divided into, at least, dedicated storage areas for “image 1” data, a “image 2” data, “image 3” data and “image 4” data, a synthesis processing area in which the “image 1”˜“image 4” data are synthesized or reduced and a display area in which display image data resulting from culling processing implemented in correspondence to the display resolution of the LCD color monitor 3 are stored. Examples of the images stored in the various areas are shown on the right side of the figure. In the figure, the “image 1” is an image captured by the CCD 202, the “image 2” is an image in the frame that has been most recently recorded at the memory 208, the “image 3” is the image in the frame immediately preceding the most recently recorded frame and the “image 4” is the image in the frame preceding the most recently recorded frame by two frames.

The image displayed on the LCD color monitor 3 of the electronic still camera 1 corresponds to the image data stored in the display area shown at the bottom of FIG. 13. When the electronic still camera 1 is set in the photographing mode and the quick review button 10 is operated while the through image display shown in FIG. 3 is up on the LCD color monitor 3, the image processing ASIC 206 reads out the image data corresponding to three successive frames starting with the most recently recorded frame from the memory 208 such as a CF card. The image processing ASIC 206 decompresses the image data thus read out and stores them in the corresponding “image 2”˜“image 4” areas in the buffer memory 207 in FIG. 13.

The individual sets of image data stored in the “image 2”˜“image 4” areas of the buffer memory 207 are culled by the image processing ASIC 206 so that their display areas are each reduced to 1/9 of the full screen display based upon a specific reduction rate set in advance. The “image 2”˜“image 4” data having undergone the culling processing are then synthesized with the “image 1” data stored in the “image 1” area of the buffer memory 207 and the synthesized data are copied into the synthesis processing area of the buffer memory 207 as shown in FIG. 13. In other words, the image data are synthesized so as to overwrite part of the “image 1” data with the thumbnail data of the reduced “image 2”˜“image 4”.

The synthesized image in the synthesis processing area of the buffer memory 207 undergoes culling processing in correspondence to the display resolution of the LCD color monitor 3, and when the synthesized image data having undergone the culling processing are written into the display area of the buffer memory 207, a picture-in-picture display is brought up on the LCD color monitor 3. Namely, the “image 2”˜“image 4” in 1/9 size are superimposed on the through image, i.e., the “image 1”, as reproduced thumbnail images in the display. The “image 2” in the most recently recorded frame among the thumbnail images is emphasized with a bold border in the display.

If the quick review button 10 is operated again in this state, the image processing ASIC 206 overwrites the display area of the buffer memory 207 with the image data emphasized with the bold border among the “image 2” through the “image 4” on thumbnail display, e.g., the “image 2” data stored in the “image 2” area of the buffer memory 207. As a result, the full screen display of the “image 2” is brought up on the LCD color monitor 3. Subsequently, each time the quick review button 10 is operated, the image processing ASIC 206 alternately overwrites the display area of the buffer memory 207 with the image data having been stored in the synthesis processing area of the buffer memory 207 and the “image 2” data having been stored in the “image 2” area of the buffer memory 207. Thus, the picture-in-picture display and the full screen display of the generated image, i.e., the “image 2” are alternately brought up on the LCD color monitor 3. The quick review mode is cleared when the halfway press switch 231 is operated, and once the quick review mode is cleared, the operation returns to the normal photographing mode.

The operation of the AF area selector buttons 11c and 11d in the quick review mode in the second embodiment is explained. If the AF area selector button 11c or 11d is operated in the quick review mode, the image processing ASIC 206 switches the frame number of the image data to be read out from the memory 208. If the AF area selector button 11c is operated while the thumbnail images are on display, the border of the “image 3” data corresponding to the frame immediately preceding the currently emphasized data becomes emphasized in the display. If the AF area selector button 11c is operated again, the border of the “image 4” data in the frame preceding the currently emphasized data by two frames becomes emphasized. If the AF area selector button 11c is operated again while the border of the image on the left side among the three thumbnail images is emphasized, the image processing 206 reads out the image data in the frames preceding the frame of the image data most recently recorded at the memory 208 by three˜five frames, decompresses them and overwrites the “image 2”˜“image 4” areas of the buffer memory 207 with the decompressed image data.

If, on the other hand, the AF area selector button 11d is operated, the border of the image data in the frame immediately following the currently emphasized image data is emphasized in the display. If the AF area selector button 11d is operated while the border of the image on the right side among the three thumbnail images is emphasized, image data in three new frames toward the most recently recorded frame are read out and decompressed, and the “image 2˜“image 4” areas of the buffer memory 207 are overwritten with the decompressed image data.

As explained above, the second embodiment achieves the following advantages.

(1) Photographic images in three frames that have already been recorded at the memory 208 are superimposed on the through image captured by the CCD 202, i.e., the “image 1” data, as thumbnail images in the display on the LCD color monitor 3 by pressing the quick review button 10 in the photographing mode. Thus, photographed thumbnail images can be checked while viewing the subject image to be photographed next in the “image 1”. Since photographed images in three frames are displayed, the frame in which the photographed image that the user wishes to check is recorded can be located with ease even when the user is not certain which frame that image occupies.

(2) The frames corresponding to the thumbnail images read out from the memory 208 and displayed on the LCD color monitor 3 can be switched by operating the AF area selector buttons 11c and 11d. Thus, images in three successive frames can be easily selected and displayed, thereby achieving ease of operation.

Third Embodiment

In the third embodiment, image data are recorded in a different manner at the memory 208 in step S117 in FIG. 11 explained earlier. The CPU 212 records image data at the memory 208 by adding thumbnail image information to image data having undergone compression processing. The thumbnail image information is prepared by the image processing ASIC 206 by reducing the size of the image constituted of image data through culling to, for instance, 160 pixels×120 pixels. In other words, the image data and the thumbnail image information of the same image data are recorded together at the memory 208.

If the quick review button 10 is operated for the first time while the through image display shown in FIG. 3 is up on the LCD color monitor 3 of the electronic still camera 1, the image processing ASIC 206 reads out the thumbnail image information of the most recently recorded image data from the memory 208. The image processing ASIC 206 stores the thumbnail image information thus read out into the “image 2” area of the buffer memory 207 in FIG. 6.

The thumbnail image information having been stored in the “image 2” area of the buffer memory 207 then undergo enlargement or reduction processing implemented by the image processing ASIC 206 so as to reduce the display area to ¼ of the full screen display based upon a specific reduction rate set in advance. The thumbnail image information having undergone the processing are synthesized with the “image 1” data stored in the “image 1” area of the buffer memory 207 and the synthesized data are copied into the synthesis processing area of the buffer memory 207. In other words, the image data are synthesized so as to overwrite part of the “image 1” data with the thumbnail image information constituting the “image 2” data.

The synthesized image resulting from the synthesis processing performed in the synthesis processing area of the buffer memory 207 undergoes culling processing implemented in correspondence to the display resolution of the LCD color monitor 3. When the synthesized image data resulting from the culling processing are written in the display area of the buffer memory 207, picture-in-picture display is brought up on the LCD color monitor 3. Namely, the reproduced image, i.e., the “image 2”, in a ¼ size is displayed over the through image, i.e., the “image 1”. Since the through image is displayed over ¾ of the display screen of the LCD color monitor 3, reproduction/display of the recorded image is enabled while the display screen is still utilized as an electronic view finder. If the AF area selector button 11c or 11d is operated in this state, the image processing ASIC 206 switches the frame number of the thumbnail image information to be read out from the memory 208.

When the quick review button 10 is operated for a second time, the image processing ASIC 206 reads out the image data having been recorded together with the thumbnail image information currently on display from the memory 208. The image processing ASIC 206 decompresses the image data thus read out and overwrites the ‘image 2” area of the buffer memory 207 in FIG. 6 with the decompressed image data. As a result, the full screen display of the “image 2” is brought up on the LCD color monitor 3. While the length of the processing time increases compared to the processing for displaying an image based upon thumbnail image information since decompression processing must be implemented on image data read out from the memory 208 to bring up the full screen display of the image corresponding to the image data, the photographer wishes to thoroughly check the image in this situation and therefore, it does not present a problem.

As explained above, image data and thumbnail image information created by culling and reducing the image data to a predetermined size are recorded together at the memory 208. When the quick review button 10 is pressed in the photographing mode, the thumbnail image information recorded at the memory 208 is read out and is superimposed on the through image captured by the CCD 202 in the display on the LCD color monitor 3. Since the information volume of the thumbnail image information is much smaller than the volume of the image data, the length of time required to implement the processing for bringing up pictures in picture display can be reduced compared to the method adopted in the first embodiment in which the display processing is performed after reading out the image data. As a result, a reproduced image can be displayed within a very short period of time.

While the “image 2”˜“image 4” areas, the “image 1” area, the synthesis processing area and the display area in the buffer memory 207 are independent of one another in the explanation given above, areas within the buffer memory 207 may be integrated in conformance to the actual processing mode to implement, for instance, synthesis processing concurrently during the decompression processing.

In addition, while the display reduction rate for a reproduced image to be displayed in the “picture-in-picture” display is ¼ of the full screen size in the first embodiment and the third embodiment and 1/9 of the full screen size in the second embodiment in the explanation given above, the reduction rate is not limited to these values. For instance, if the LCD color monitor 3 has a large display screen, reproduced images may be displayed in an even smaller size.

As shown in FIG. 7, the camera operations for photographing are held or continued in the quick review mode. Instead, the drive of the CCD 202 and the drive of the driver 203 that drives the CCD 202 may be stopped even in the quick review mode when the quick review mode has been sustained over a specific length of time or longer in a state in which the photographic zoom lens 2 of the electronic still camera 1 is turned downward, by providing a camera attitude detection sensor at the electronic still camera 1. In such a case, a reduction in the power consumption at the electronic still camera 1 is achieved when the camera is not engaged in a photographing operation for a considerable length of time such as when the photographer looks at a reproduced image for some time in the quick review mode.

While an explanation is given above on an example in which the present invention is adopted in the electronic still camera 1, the present invention is not limited to these details, and may be adopted in a video camera that captures dynamic images and has a function of capturing and recording still images. In addition, the present invention may be adopted in a personal computer or a mobile telephone mounted with a CCD camera or the like to capture still images. In other words, the present invention may be adopted in all types of image-capturing apparatuses having a function of capturing a still image of a subject and recording the captured still image at a recording medium.

It is to be noted that when the present invention is adopted in a personal computer, the program executed in the electronic still camera 1 described above is provided to the personal computer via a recording medium such as a CD-ROM, through the Internet or the like.

What is claimed is:

1. An image-capturing apparatus comprising:
an image-capturing element that captures an image of a subject through a photographic lens and outputs the captured image of the subject as image data;
a display device that displays the image of the subject;
a recording device that records said image data at a recording medium;
a display control device that displays a first image prepared based upon the image data output by the image-capturing element and a second image prepared based upon the image data recorded at said recording medium on said display device; and
an instruction device that issues an instruction to said display control device to display the first image and the second image in response to a user instruction operation when the first image is on display at said display device.

2. An image-capturing apparatus according to claim 1, further comprising:
a switching signal output device that outputs a signal for switching a frame of the second image which is currently on display at said display device, wherein:
said display control device switches the frame of the second image based upon a signal output from said switching signal output device.

3. An image-capturing apparatus according to claim 1, wherein:
said display control device implements control on said display device so as to display at least two frames of the second image.

4. An image-capturing apparatus according to claim 1, wherein:
said display control device reduces the second image and implements control on said display device so as to display the reduced second image by superimposing the reduced second image over a portion of the first image.

5. An image-capturing apparatus according to claim 4, wherein:
said instruction device issues an instruction to said display control device so as to display an image by enlarging the reduced second image in response to a user instruction operation when the second image having been reduced is on display; and
said display control device implements control on said display device so as to display the second image instead of the first image when said instruction device has issued an instruction to display an image by enlarging the reduced second image.

6. An image-capturing apparatus comprising:
an image-capturing element that captures an image of a subject through a photographic lens and outputs the captured image of the subject as image data;
a display device that displays the image of the subject;
a recording device that records said image data in a recording medium and records reduced image data created by reducing said image data at said recording medium;
a display control device that displays a first image prepared based upon said image data output by the image-capturing element and a second image prepared based upon said reduced image data having been recorded at said recording medium on said display device; and
an instruction device that issues an instruction to said display control device to display said first image and said second image in response-to a user instruction operation when said first image is on display at said display device.

7. An image-capturing apparatus according to claim 6, wherein:
said display control device implements control on said display device so as to display said second image by superimposing said second image over a portion of said first image.

8. An image-capturing apparatus according to claim 6, wherein:
said instruction device issues an instruction to said display control device so as to display an image by enlarging said second image in response to a user instruction operation when said second image is currently on display; and
when said instruction device has issued an instruction to display an image by enlarging said second image, said display control device implements control on said display device so as to display an image prepared based upon the image data recorded at said recording medium corresponding to the reduced image data with regard to which said instruction has been issued.
